(19) United States
(12) Patent Application Publication
(10) Pub. No.: US 2012/0193039 A1
(43) Pub. Date: Aug. 2, 2012

(54) WINDOW SHADE WITH REFLECTIVE AND AESTHETIC FEATURES

(76) Inventor: Nathan A. Scolari, Greenville, SC (US)

(21) Appl. No.: 13/365,135

(22) Filed: Feb. 2, 2012

Related U.S. Application Data
(60) Provisional application No. 61/438,786, filed on Feb. 2, 2011.

(51) Int. Cl. E06B 9/386

(52) U.S. Cl. 160/115; 160/236; 160/113

(57) ABSTRACT

This invention is directed to a window shade comprising a plurality of slats carried by a retracting member; a reflective layer included in each slat wherein the reflective layer reflects natural light away from a structure when the slats are in a first position and reflects light into the interior of a structure when the slat are in a second positions; and, an image segmented onto each of the slats so that when the slats reflect light into the interior of a structure, the image is integrated and reflected on the ceiling of the interior of the structure.

### CLAIM OF PRIORITY

This application claims priority on U.S. Patent Application Ser. No. 61/438,786 filed Feb. 2, 2011.

### BACKGROUND OF THE INVENTION

1. Field of the Invention

This invention is directed to a window shade that includes various slats for reflecting away from and into a room as well as reflecting aesthetic patterns into the room.

2. Description of the Related Art

Shades and blinds have been used to block light from the sun for hundreds of years. Pleated retractable shades were even used in the Roman Coliseum. The benefits of window shades and the like are to prevent light and heat from entering the interior of a structure, or to keep light and heat off of individuals that are in direct sunlight. Much attention has been directed to keeping light and heat out of a room of a structure such as with U.S. Pat. No. 2,874,612 issued in 1956 and disclosing a thermal insulator. This reference includes a shade that has a heat blocking layer and light blocking layer for covering a window of a structure. Blinds have traditionally been configured to be raised and lowered so that light can be partially blocked from entering the room through the window. U.S. Pat. No. 168,221 issued in 1875 and directed to a Venetian window blind where the upper and lower parts can be adjusted independently.

In controlling light, U.S. Pat. No. 6,123,137 is directed to a light-control assembly that has an upper section and a lower section. The upper section is adapted to redirect light entering the window to reflect in the ceiling of the interior of the room. Further, the upper section can reflect light on the wall where the light-control assembly is mounted. The slats of the upper portion can have highly reflective surfaces to improve light control. Further, the slats of the upper surface can have perforations or be only partially translucent. The lower section can block light from entering the room.

Decorative aspects and improvements to window blinds have also received some attention. U.S. Pat. No. 5,682,939 discloses a window shade that can also send a message or illustrate an oriental image. This shade attachment is illuminated form the light coming from a structure so that those external to the structure can view the image. U.S. Pat. No. 3,205,118 discloses a window shade with images on the shade that are revealed when the shade is extended. U.S. Pat. No. 4,907,636 discloses a means for decorating a window shade with wallpaper or fabric. United States Patent Application 2005/0056382 discloses a window blind that includes images on the side facing the exterior of the structure that can be viewed from the exterior. This reference notes that for highly reflective, energy conserving blinds, the mirror finish was not received as aesthetically pleasing to interior designs and, therefore, difficult to market. Further, U.S. Pat. No. 2,60,078 discloses a machine for printing window shades to allow window shades to be imprinted with decorative images.

Another approach to blinds is to create aesthetic appearances in the interior of the structure. U.S. Pat. No. 5,828,494 issued in 1998 and discloses panel unit for use in a window having a plurality of vertically stacked transparent elements. When light enters the elements, it is refracted and to create a block of color or color pattern in the interior of the structure. Varying the shape of the elements results in varying color patterns reflected into the interior. Using prisms has been known for reflecting light in windows for some time as shown in U.S. Pat. No. 595,264, issued in 1897. This reference discloses prism lights applied to windows of apartments. Further, U.S. Pat. No. 2,381,542 issued in 1945 discloses a coated glass fabric for reflecting light with varying colors for the coating and glass. Internally, glass panels have been used to reflect light within a room as disclosed in U.S. Pat. No. 1,669,663 issued in 1928. U.S. Pat. No. 3,393,034 discloses a lighting device that only allows light with certain incidents of angle to pass into the room. This prevents the panel from completely blocking the light, thereby resulting in a room that tends to be described as gloomy.

None of these attempts to provide interior lighting in combination with a window shade without the bulkiness of glass, prism or other such devices has been accomplished.

There have also been many attempts to try to reflect light into a room that can use the sunlight or natural light for illumination. For example, U.S. Pat. No. 4,989,952 is directed to a method for producing a transparent light deflecting panel by making a series of parallel cuts in a sheet of transparent solid material with a laser cutting tool. The panel, when positioned in an opening in the facade of a building, deflects incident daylight towards the ceiling. U.S. Pat. No. 4,699,467 includes daylight entering an inlet limited by a flat upper reflector and a bottom parabolic lower reflector. U.S. Pat. No. 6,580,559 discloses an optically transparent main body through which the light is incident into the respective room, and including a plurality of structures on which light is deflected by total reflection into the respective room, wherein said plurality of structures consists of parallel crazes (flat wedge-shaped deformation centers having a refractive index as variance from the index of the basic material, in vitreous thermoplastic materials). Further, U.S. Pat. No. 6,318,441 discloses a window covering system which includes a plurality of horizontal slats which are tiltable to control entry of light. The slats include a light processing section which may be a transparent or translucent plastic and an opaque section which may be aluminum. The slats have a complex curvature which processes and diffuses light into the interior with preventing direct sunlight beams from penetrating into the interior.

However, none of these attempts provides the ability to reflect specialized images, designs or other asymmetrical images in the interior of a room.

Therefore, it is an object of this invention to provide for a simply constructed window blind that blocks light in one configuration and allows light to enter by reflecting images or scenes within the room without relying upon glass prisms.

It is another object of this invention to provide natural light reflected into a room for rooms with limited natural light penetration due to the location, configuration or physical surroundings of an opening such as a window.

### SUMMARY OF THE INVENTION

Accordingly, the object of the present invention is accomplished by providing a window shade comprising: a plurality of slats carried by a retracting member; a reflective layer included in each slat wherein said reflective layer reflects natural light away from a structure when said slats are in a first position and reflects light into the interior of a structure when said slats are in a second position; and, an image segmented onto each of said slats so that when said slats reflect light into the interior of a structure, said image is integrated and reflected on the ceiling of the interior of the structure.

The invention can also include a first and second transparent layer included in said slat; and, a reflective layer sandwiched in between said first and said second transparent layer. A portion of an integrated image can be included on each of said slats so that when light is reflected off the slats, said integrated image is reflected into the interior of said structure. A mosaic pattern or stained glass can be included in each slat.

The window shade can include a first set of slats which can rotate independently of a second set of slats. A first image can be included in said first set of slats and a second image can be included in said second set of slats.

A reflector connected to said structure operatively associated with said slats to that natural light is reflected from a light source off said reflector and onto said bottom of said slats so that light can be reflected onto the ceiling of the interior of said structure. The reflector is flexible having a first position extended away from said structure to reflect light and a second position wherein said reflector is gathered and stored in proximity to said structure.

### DESCRIPTION OF THE DRAWINGS

The invention will be more readily understood with the following drawings incorporated into the specification.

FIG. 1 shows side and perspective views of the invention;

FIG. 2 shows side and perspective views of the invention;

FIG. 3 shows a perspective view of the invention;

FIG. 4 shows a side view of the invention;

FIG. 5 shows a side view of the invention; and,

FIG. 6 shows a side view of the invention.

### DESCRIPTION OF A PREFERRED EMBODIMENT

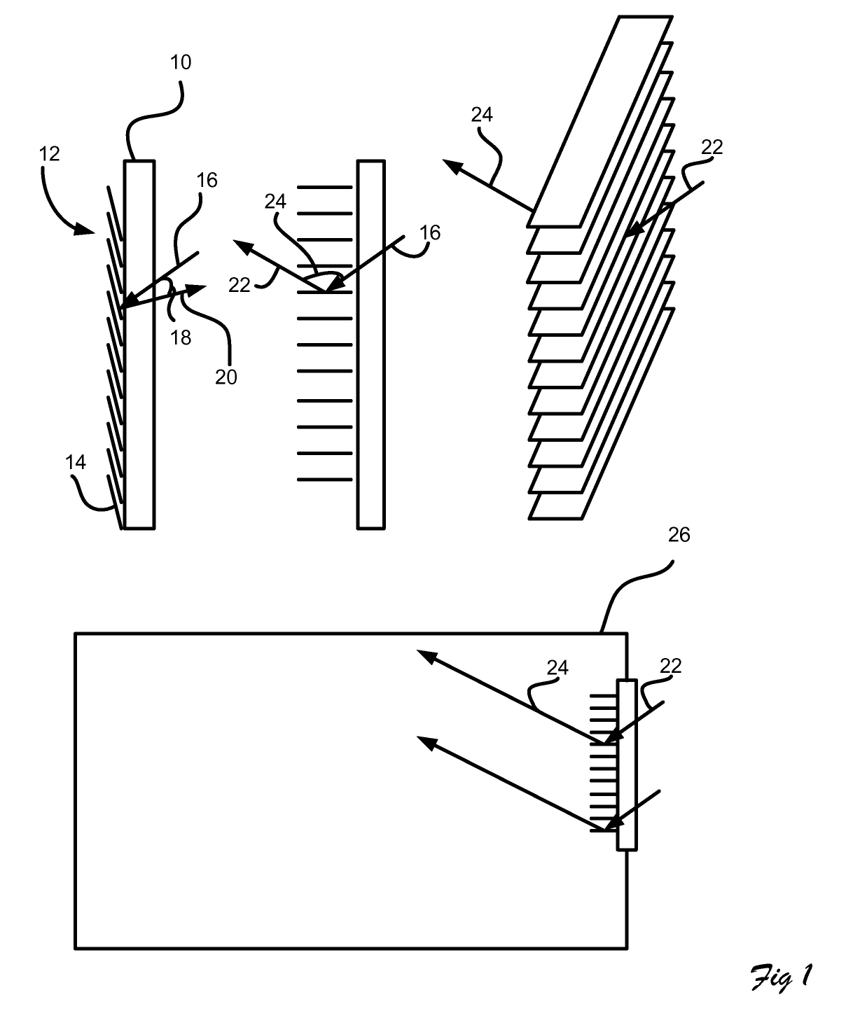

This invention is directed to a window shade to block slats in one configuration which allows reflective light to enter the room in another configuration. Referring to FIG. 1, window 10 is shown with window shade 12 installed adjacent to the window. The window shade is made from a plurality of slats 14. When in the closed arrangement, sunlight 16 reflects off the slats at angle 18 in direction 20 thereby preventing heat and light from entering the interior of the structure. When in the open positions, the slats are arranged in a manner allowing sunlight 16 to reflect off the slat in a direction 22 at angle 24. When in this configuration, the sunlight can be reflected onto the ceiling of the interior room 26.

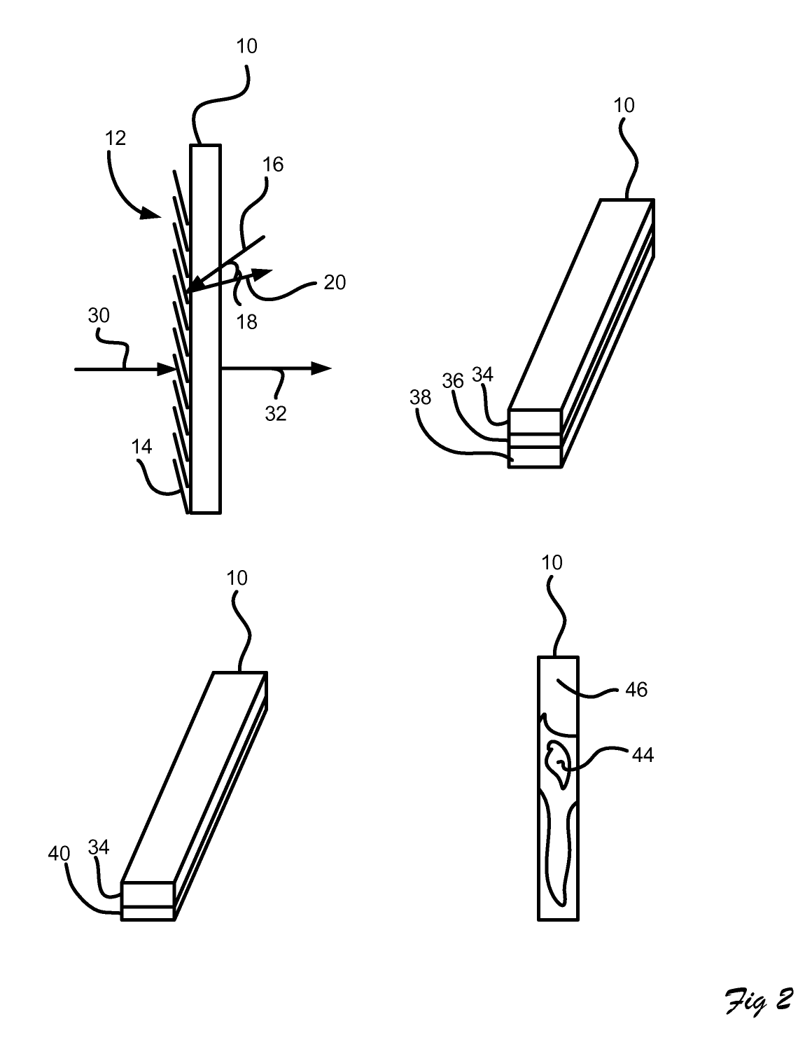

Referring to FIG. 2, another embodiment is shown. The slats are generally translucent with a coating on or sandwiched in the slats. The coating allows light initially travelling in a direction 16 to be reflected in a direction 20. This prevents light from external of the structure from entering the interior of the structure. Privacy is obtained since an individual exterior of the structure cannot see into the interior of the structure. However, the film allows light 30 originating in the interior of the structure to exit the structure as light 32 allowing someone in the interior of the structure to see outside of the window. In this embodiment, slat 10 (shown exaggerated) can include a first transparent layer 34 and a second transparent layer 38 sandwiching a semi-transparent layer 36. In one embodiment, layer 38 can be omitted.

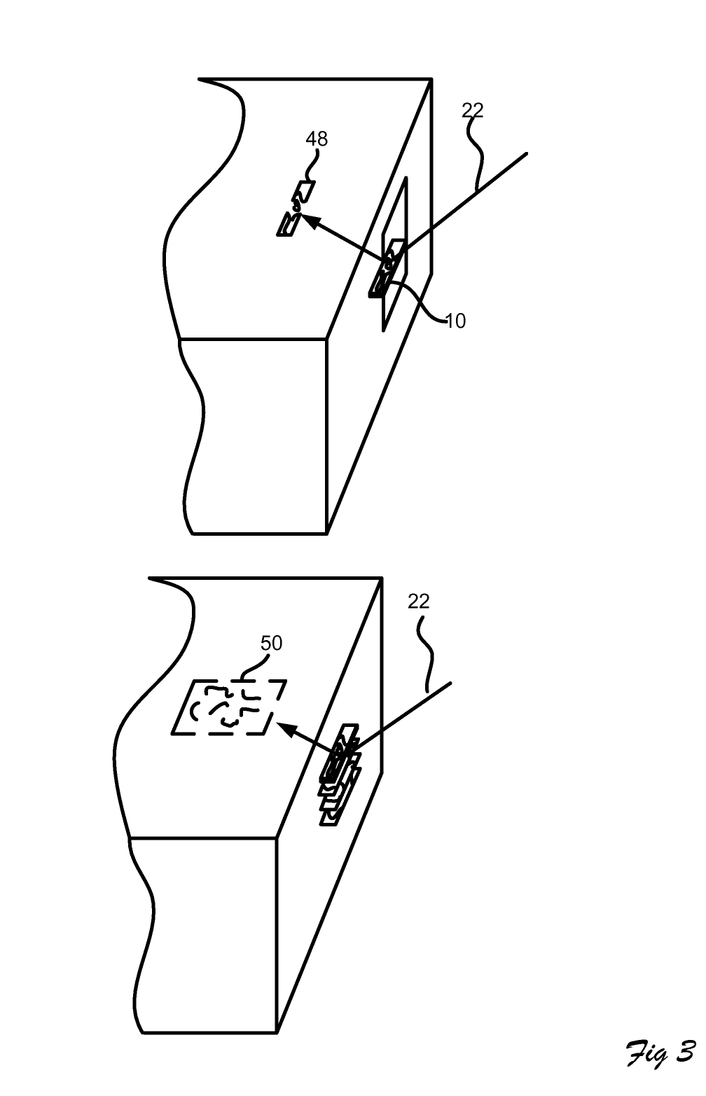

In another embodiment, transparent layer 34 is adjacent to imprinted layer 40. The imprinted layer has an image 42 that is reflective (or semi-reflective) of certain reflectance in specific areas. For example, area 44 may have a higher reflectance than area 46. Referring to FIG. 3, the different areas can have a different reflective color so that when light 22 is reflected off slat 10, an image 48 is reflected onto the ceiling. When light hits the arrangement of slats, the separations between the slats creates different angles of reflection. Each slat can have a different portion of an integrated image so that when light hits the combination of slats, an integrated image 50 is reflected on the ceiling. By changing the angle of the slats, the image can be modified as the angle of reflection changes for each of the slats. Further, the slats can include a one-way stained glass that provides an aesthetically pleasing stained glass image on the interior of the structure, while providing an opaque surface for providing privacy from individuals on the exterior of the structure. The slats can have varying degrees of transparency for differing effects. The slats can also be polarized for producing varying effects.

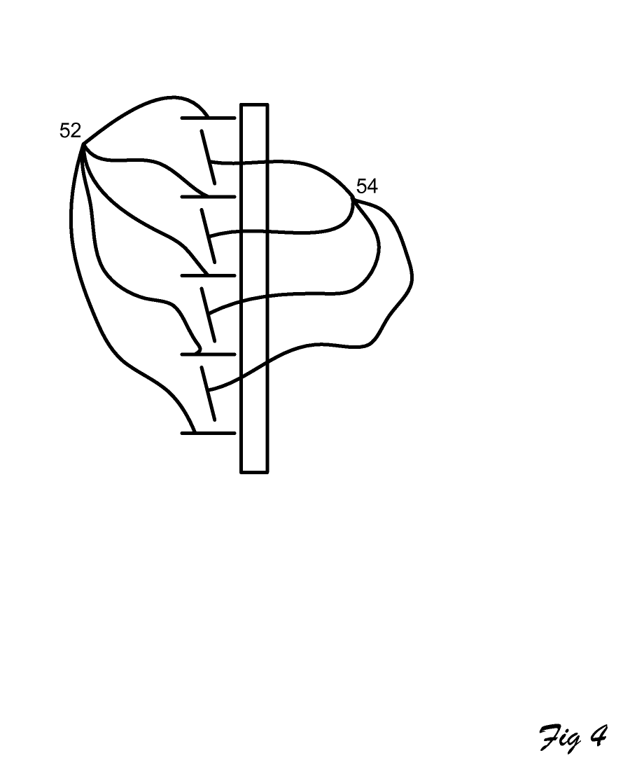

Referring to FIG. 4, one embodiment is shown wherein slats can be arranged in an alternating configuration. A first group of slats 52 are interlaced with a second group of slats 54. The first group can be opened or closed independent of the second group. This allows for window blind to be open, closed or partially open or closed.

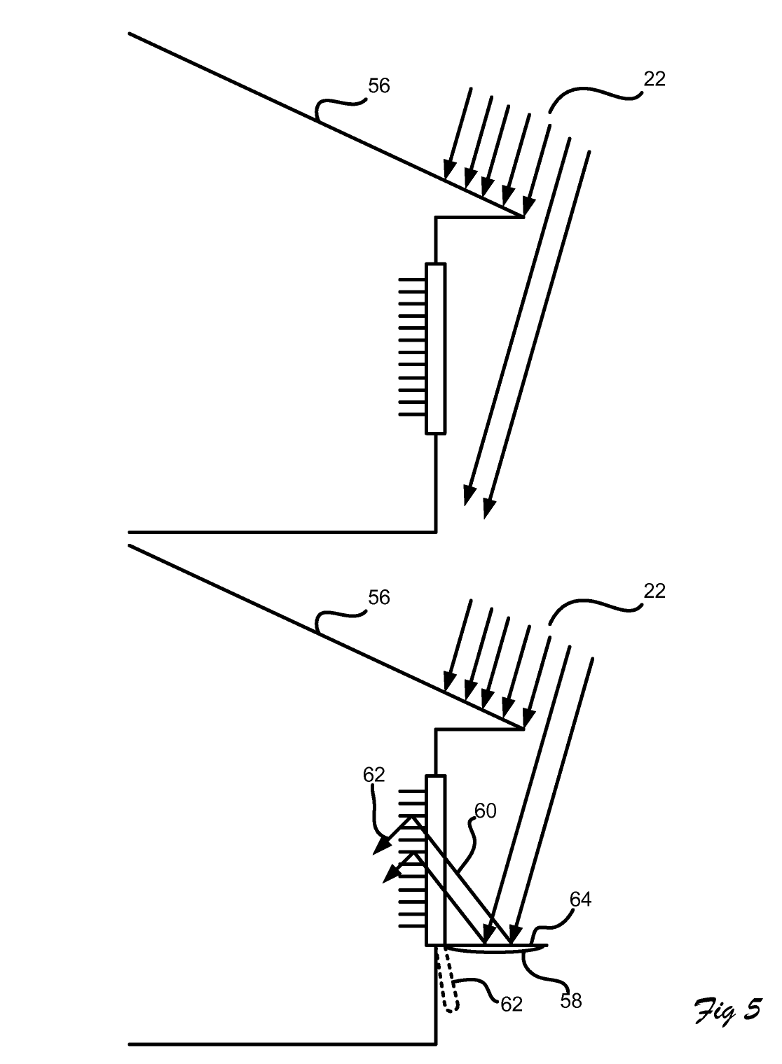

Referring to FIG. 5, light 22 transmitted from the sun is unable to reach the window as it is blocked by roof 56. Therefore, the advantages of the present invention are undermined. To remedy this disadvantage, a reflector 58 can be attached to the exterior of the structure so that light 22 is reflected off the structure in a direction shown as 60. In this case, the light can reflect off the underside of the slats and be reflected on the floor of the structure. In one embodiment, the reflector is made from a flexible material and can be stored folded against the structure as shown by 62. When poles 64 are extended, the flexible material is also extended and reflects the sunlight into the structure.

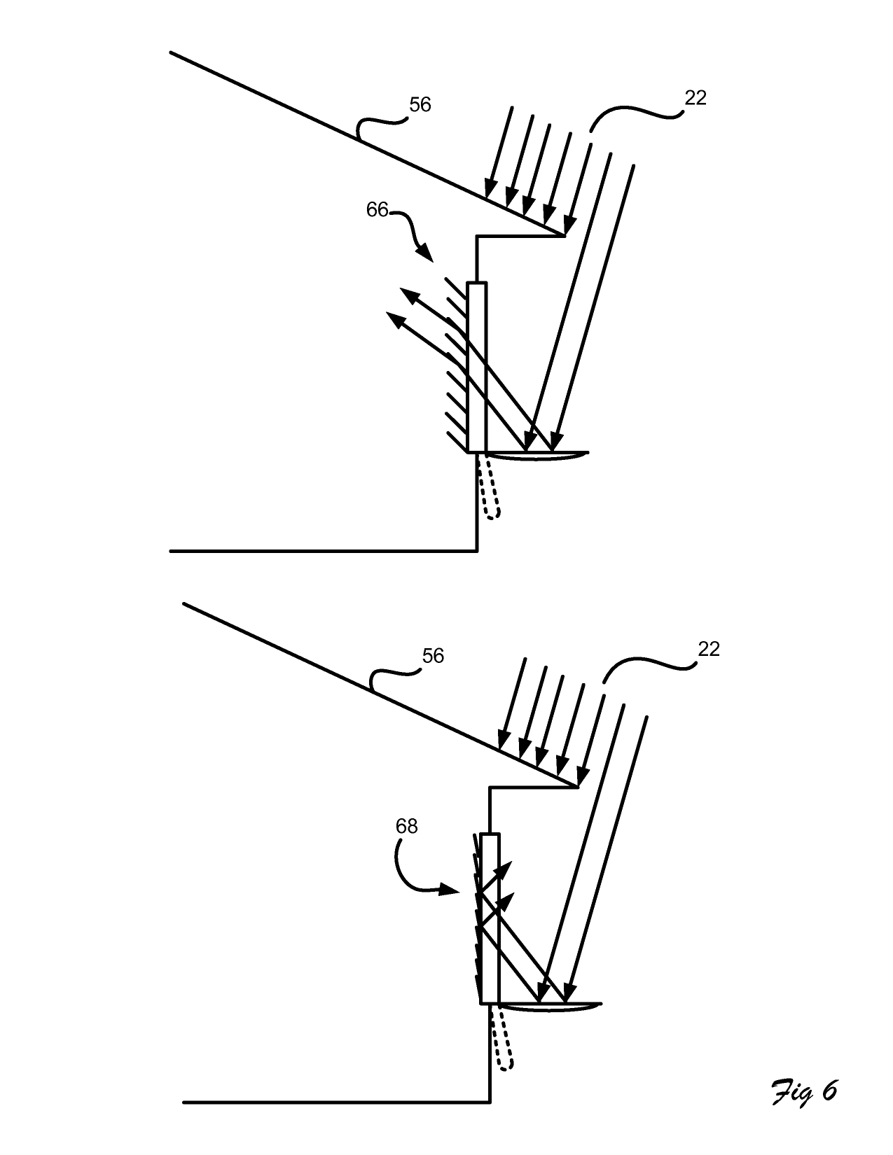

Referring to FIG. 6, when the slats are in the configuration shown as 66, light 22 reflects off the reflector and is then reflected off the bottom of the slats at glancing angle so that the light is reflected onto the ceiling of the structure. When the light hits the slats in configuration 68 (closed), the light is reflected away from the interior of the structure.

The shades can be operated through manual means such as pull cords, twisting rods, or the like, as well as motorized means. Further, the slats can be installed in the interior of the room, within panes of glass comprising the windows or external to the structure adjacent to the windows. The reflector can be manually operated or motorized or extended or retracted in cooperation with the slats. Both the slats and the reflector can be operated on a timer in consideration of the position of the sun optimizing the light treatments within the interior of the structure.

While the invention has been described with reference to certain exemplary embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A window shade comprising:
a plurality of slats carried by a retracting member;
a reflective layer included in each slat wherein said reflective layer reflects natural light away from a structure when said slats are in a first position and reflects light into the interior of a structure when said slats are in a second position; and,
an image having image segments wherein each of said slats carries an image segment so that when said slats reflect light into the interior of a structure, said image is reflected on the ceiling of the interior of the structure.

2. The window shade of claim 1 including:
a first and second transparent layer included in said slat; and,
a reflective layer sandwiched in between said first and said second transparent layer.

3. The window shade of claim 1 wherein said image including mosaic patterns included in each slat.

4. The window shade of claim 1 including stained glass carried by each slat.

5. The window shade of claim 1 including a first set of slats which can rotate independently of a second set of slats.

6. The window shade of claim 1 wherein a first image is included in said first set of slats and a second image is included in said second set of slats.

7. The window shade of claim 1 including an absorption layer included in each slat opposite said reflective layer so that natural light is absorbed and is not reflected into the interior of the structure when said slats are in said first position

8. The window shade of claim 1 including a reflector connected to said structure operatively associated with said slats so that natural light is reflected from a light source, off said reflector and onto said bottom of said slats.

9. The window shade of claim 8 wherein said light is reflected onto the ceiling of the interior of said structure.

10. The window shade of claim 8 wherein said reflector is flexible having a first position extended away from said structure to reflect light and a second position wherein said reflector is gathered and stored in proximity to said structure.

11. The window shade of claim 1 including a transparent layer adjacent to said reflective layer and an opaque layer opposite said transparent layer adjacent to said reflective layer.

12. A window shade comprising:
a retractor having a first set of rotatable slats and a second set of slats fixed in a horizontal configuration; and,
a reflective layer included in each slat wherein said reflective layer reflects natural light away from a structure when said slats are in a first position and reflects light into the interior of a structure when said slats are in a second position.

13. The windows hade of claim 12 including an image having image segments wherein each of said slats of said first set of slats carries an image segment so that when said slats reflect light into the interior of a structure, said image is reflected into the interior of the structure.

14. The window shade of claim 12 including a reflective layer included on the bottom of each of said slats of said second set of slats to reflect light off said first set of slats downward into the interior of the structure.

15. The window shade of claim 12 including a reflector connected to said structure operatively associated with said slats so that natural light is reflected from a light source, off said reflector and onto said bottom of said slats of said second set of slats.

16. A window shade comprising:
a plurality of slats carried by a retracting member;
a reflective layer included in each slat wherein said reflective layer reflects natural light away from a structure when said slats are in a first position and reflects light into the interior of a structure when said slats are in a second position; and,
a reflector operatively associated with said slats for reflecting light from a light source off said reflector and onto said slats.

17. The window shade of claim 16 wherein said reflector is rotatably carried by said structure having a first position wherein said reflector reflects light from said light source into said structure and a second position wherein said reflects light away from said structure.

18. The window shade of claim 17 including a reflective layer included in said reflector.

19. The window shade of claim 16 including an image having image segments wherein each of said slats carries an image segment so that when said slats reflect light into the interior of a structure, said image is reflected on the ceiling of the interior of the structure.

20. The window shade of claim 16 including a opaque layer on each of said slats opposite said reflective layer.
